(19) United States
(12) Patent Application Publication
(10) Pub. No.: US 2015/0205014 A1
(43) Pub. Date: Jul. 23, 2015

(54) LENS ARRAY, METHOD FOR MANUFACTURING LENS ARRAY, ELECTRO-OPTICAL DEVICE, AND ELECTRONIC APPARATUS

(71) Applicant: Seiko Epson Corporation, Tokyo (JP)

(72) Inventor: Koichiro Akasaka, Ina-shi (JP)

(21) Appl. No.: 14/599,592

(22) Filed: Jan. 19, 2015

(30) Foreign Application Priority Data
Jan. 21, 2014 (JP) 2014-008362

(51) Int. Cl. G02B 3/00

(52) U.S. Cl. CPC G02B 3/0056; G02B 3/0012

(57) ABSTRACT

A microlens array includes a unit cell group and a first lens and a second lens which are arranged in the unit cell group, in which the direction of the first lens in plan view is different to the direction of the second lens in plan view. In this manner, it is possible to suppress diffraction caused by regularity of the lenses. Accordingly, it is possible to realize the microlens array with high light utilization efficiency.

### BACKGROUND

1. Technical Field

The present invention relates to a lens array, a method for manufacturing a lens array, an electro-optical device, and an electronic apparatus.

2. Related Art

Electro-optical devices which are provided with an electro-optical material such as a liquid crystal between an element substrate and a counter substrate are known. Examples of electro-optical devices include liquid crystal devices, which are used as a liquid crystal light bulb in a projector, and the like. There is a demand for realizing high light utilization efficiency in such liquid crystal devices.

A liquid crystal device is provided with TFT elements which drive pixel electrodes, wiring, and the like in pixels on an element substrate and a light shielding layer is provided so as to be planarly overlapped therewith. Due to this, a portion of incident light is shielded by the light shielding layer and not used. Therefore, as described in JP-A-2004-70282, a configuration is known which improves light utilization efficiency by concentrating incident light with microlenses by providing a microlens array in which microlenses are arranged in at least one of an element substrate and a counter substrate in a liquid crystal device.

However, there is a problem that light utilization efficiency is poor in the microlens array according to JP-A-2004-70282. In general, in a liquid crystal device provided with a microlens array, since the pixels are regularly (periodically) arranged, the pixels become smaller as the high definition of the liquid crystal device increases, and the incident light is easily diffracted by the pixels. When a strong diffraction light is generated, the solid angle of a luminous flux which is output from the liquid crystal device is large. When a liquid crystal device which is provided with such a microlens array is used as a liquid crystal light bulb of a projector, a wide angle of light which is output from a liquid crystal device exceeds an angle of incidence regulated by an F value of a projector lens. In this case, a portion of light which is output from the liquid crystal device is not incident on the projector lens and as a result, the amount of light which is projected on a screen decreases. In this manner, in the microlens array according to JP-A-2004-70282, improvement in the brightness is limited even when a microlens array is applied to the liquid crystal device. In other words, the microlens array of the related art has a problem in that it is difficult to sufficiently increase the light utilization efficiency.

### SUMMARY

The invention can be realized in the following forms or application examples.

### Application Example 1

A lens array according to this application example includes a plurality of lenses, in which the plurality of lenses include a first lens and a second lens which are each provided with a flat portion formed of a plurality of sides, and a first lens direction which is an extended direction of one side of the flat portion of the first lens and a second direction which is an extended direction of one side of the flat portion of the second lens are different directions.

According to this configuration, it is possible to suppress diffraction caused by regularity of the lenses. Accordingly, it is possible to realize a lens array with high light utilization efficiency.

### Application Example 2

In the lens array according to the application example, the plurality of lenses may be arranged so as to include a plurality of unit cell groups formed of M×N (M is an integer of 1 or more and N is an integer of 2 or more) lenses, and extended directions of one side of a flat portion of each lens of one unit cell group out of the plurality of unit cell groups may each be different directions.

According to this configuration, it is possible to suppress diffraction caused by regularity of the lenses. Accordingly, it is possible to realize a lens array with high light utilization efficiency.

### Application Example 3

In the lens array according to Application Example 1 or 2, when an angle of the first lens direction with respect to a first direction is set as a first lens angle θ1 and an angle of the second lens direction with respect to the first direction is set as a second lens angle θ2, the first lens angle θ1 and the second lens angle θ2 may be in a range from -15° to +15°.

The unit cell group includes a plurality of cells and a lens is arranged in each of the cells. According to this configuration, it is possible to reduce a region in which a lens is not arranged inside a cell. Accordingly, it is possible to efficiently concentrate incident light which is incident on a cell and it is possible to realize a lens array with high light utilization efficiency.

### Application Example 4

In the lens array according to Application Example 2, the plurality of unit cell groups may be repeatedly arranged in a first direction.

According to this configuration, it is possible to suppress diffraction caused by regularity of the lenses. Accordingly, it is possible to realize a lens array with high light utilization efficiency.

### Application Example 5

In the lens array according to Application Example 2, the plurality of unit cell groups may have a first unit cell group and a second unit cell group, and an arrangement of a plurality of lenses which are included in the first unit cell group may be different from an arrangement of a plurality of lenses which are included in the second unit cell group.

According to this configuration, it is possible to suppress diffraction caused by regularity of the lenses. Accordingly, it is possible to realize a lens array with high light utilization efficiency.

### Application Example 6

In the lens array according to Application Example 2, the plurality of unit cell groups may have a first unit cell group and a second unit cell group, and the number of a plurality of lenses which are included in the first unit cell group may be different from the number of a plurality of lenses which are included in the second unit cell group.

According to this configuration, it is possible to suppress diffraction caused by regularity of the lenses. Accordingly, it is possible to realize a lens array with high light utilization efficiency.

### Application Example 7

A method for manufacturing a lens array according to this application example includes forming a first transparent material, forming a mask layer which has a first opening portion formed of a plurality of sides and a second opening portion formed of a plurality of sides on the first transparent material, forming a plurality of concave portions in the first transparent material by carrying out isotropic etching on the first transparent material via the mask layer, and filling the plurality of concave portions with a second transparent material which has a different refractive index from a refractive index of the first transparent material, in which an extended direction of one side of the first opening portion and an extended direction of one side of the second opening portion are different directions.

According to this method, it is possible to suppress diffraction caused by regularity of the lenses. Accordingly, it is possible to realize a lens array with high light utilization efficiency.

### Application Example 8

A method for manufacturing a lens array according to this application example includes forming a second transparent material, forming a photoresist which forms a first shape formed of a plurality of sides and a photoresist which forms a second shape formed of a plurality of sides on the second transparent material, reflowing the photoresist which forms the first shape and the photoresist which forms the second shape, forming a plurality of convex sections on the second transparent material by carrying out anisotropic etching on the photoresist which forms the first shape, the photoresist which forms the second shape, and the second transparent material, and covering the plurality of convex sections with a first transparent material which has a different refractive index from the refractive index of the second transparent material, in which an extended direction of one side of the first shape and an extended direction of one side of the second shape are different directions.

According to this method, it is possible to suppress diffraction caused by regularity of the lenses. Accordingly, it is possible to realize a lens array with high light utilization efficiency.

### Application Example 9

An electro-optical device includes the lens array according to any one of Application Examples 1 to 6.

According to this configuration, it is possible to realize an electro-optical device in which light utilization efficiency is high and a bright display is possible. Application Example 10

An electro-optical device includes a lens array which is manufactured by the method for manufacturing a lens array according to Application Example 7 or 8.

According to this configuration, it is possible to realize an electro-optical device in which light utilization efficiency is high and a bright display is possible.

### Application Example 11

An electronic apparatus includes the electro-optical device according to Application Example 9 or 10.

According to this configuration, it is possible to realize an electronic apparatus which is provided with an electro-optical device in which light utilization efficiency is high and a bright display is possible.

### BRIEF DESCRIPTION OF THE DRAWINGS

The invention will be described with reference to the accompanying drawings, wherein like numbers reference like elements.

FIG. 1 is a schematic planar diagram which shows a configuration of a liquid crystal device according to Embodiment 1.

FIG. 2 is an equivalent circuit diagram which shows an electrical configuration of the liquid crystal device according to Embodiment 1.

FIG. 3 is a schematic cross-sectional diagram which shows a configuration of the liquid crystal device according to Embodiment 1.

FIG. 4 is a planar diagram which illustrates a configuration of a microlens array according to Embodiment 1.

FIGS. 5A to 5C are planar diagrams which illustrate a microlens according to Embodiment 1.

FIG. 6 is a diagram which illustrates a planar cell arrangement of the microlens array according to Embodiment 1.

FIGS. 7A to 7D are schematic cross-sectional diagrams which show a method for manufacturing the microlens array according to Embodiment 1.

FIGS. 8A to 8C are schematic cross-sectional diagrams which show a method for manufacturing the microlens array according to Embodiment 1.

FIG. 9 is a schematic diagram which shows a configuration of a projector as an electronic apparatus according to Embodiment 1.

FIG. 10 is a diagram which illustrates an example of a microlens array according to Embodiment 2.

FIG. 11 is a diagram which illustrates an example of a microlens array according to Embodiment 3.

FIGS. 12A and 12B are diagrams which illustrate an example of a microlens array according to Embodiment 4.

FIGS. 13A to 13E are schematic cross-sectional diagrams which show a method for manufacturing a microlens array according to Embodiment 5.

FIGS. 14A to 14C are diagrams which illustrate an example of a microlens according to modification example 1.

### DESCRIPTION OF EXEMPLARY EMBODIMENTS

Below, description will be given of an embodiment which embodies the invention with reference to diagrams. The diagrams which are used are displayed by being appropriately enlarged, reduced, or magnified such that the portion to be illustrated is in a recognizable state. In addition, there are cases in which configuration elements other than the constituent elements which are necessary for the description are omitted from the diagrams.

Here, in the forms below, a case of being described as “on a substrate” represents a case of being arranged so as to come into contact with the top of the substrate, a case of being arranged on the substrate via another component, or a case of being arranged such that a portion comes into contact with the top of the substrate and a portion is arranged via another component.

### Embodiment 1

### Electro-Optical Device

Here, description will be given with an active matrix type liquid crystal device which is provided with a thin film transistor (TFT) as a switching element of a pixel as an example of an electro-optical device. The liquid crystal device is able to be favorably used, for example, as an optical modulator (a liquid crystal light bulb) of a projection type display apparatus (a projector) which will be described below.

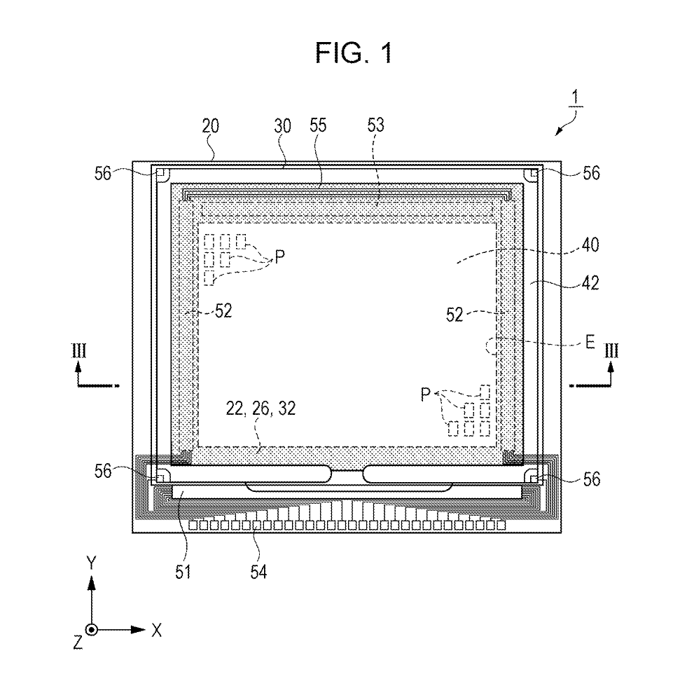

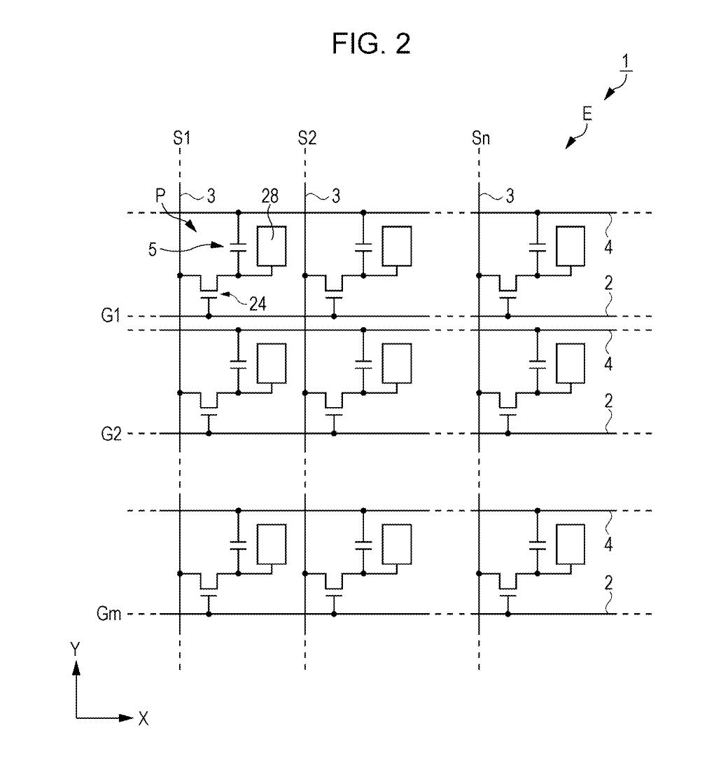

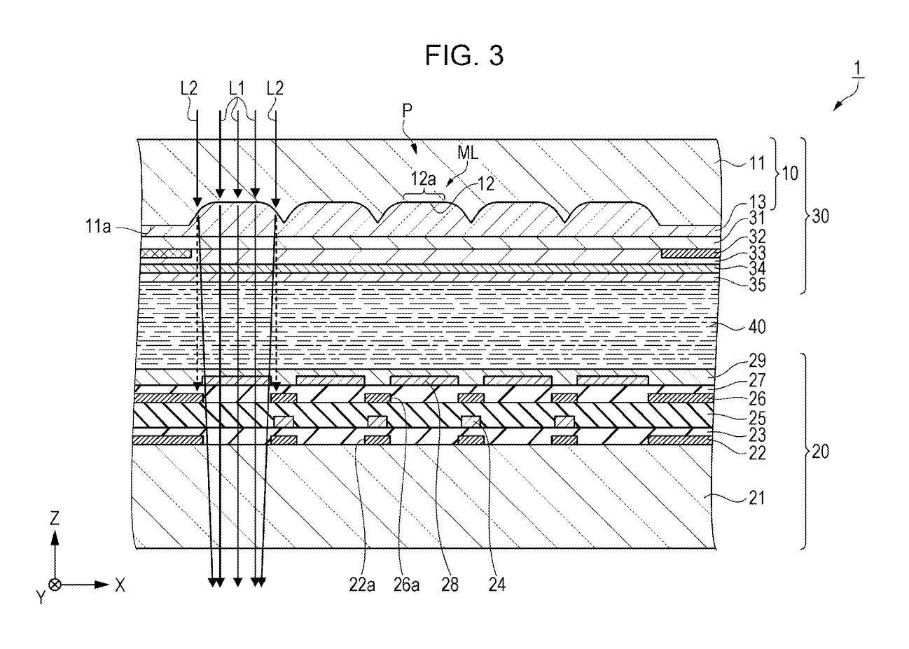

FIG. 1 is a schematic planar diagram which shows a configuration of a liquid crystal device according to Embodiment 1. FIG. 2 is an equivalent circuit diagram which shows an electrical configuration of the liquid crystal device according to Embodiment 1. FIG. 3 is a schematic cross-sectional diagram which shows a configuration of the liquid crystal device according to Embodiment 1, in detail, a partial schematic cross-sectional diagram taken along line III-III in FIG. 1. Firstly, description will be given of a liquid crystal device 1 according to Embodiment 1 with reference to FIG. 1, FIG. 2, and FIG. 3.

As shown in FIG. 1 and FIG. 3, the liquid crystal device 1 according to Embodiment 1 is provided with an element substrate 20 as a first substrate, a counter substrate 30 as a second substrate which is arranged to oppose the element substrate 20, a sealing material 42, and a liquid crystal 40 as an electro-optical material. The element substrate 20 and the counter substrate 30 are arranged to oppose each other. As shown in FIG. 1, the element substrate 20 is larger than the counter substrate 30 and both of the substrates are bonded via the sealing material 42 which is arranged in a frame shape along an edge section of the counter substrate 30.

As shown in FIG. 1, the liquid crystal 40 is held in a space which is surrounded by the element substrate 20, the counter substrate 30, and the sealing material 42 and has a positive or negative dielectric anisotropy. The sealing material 42 is, for example, formed of an adhesive agent such as a thermosetting or ultraviolet curable epoxy resin. A spacer (which is not shown in the diagram) for maintaining a constant interval between the element substrate 20 and the counter substrate 30 is mixed in the sealing material 42.

A light shielding layer 22, a light shielding layer 26, or a light shielding layer 32 as a light shielding section which has a frame shaped periphery section is provided inside the sealing material 42 which is arranged in a frame shape. The light shielding layer 22, the light shielding layer 26, or the light shielding layer 32 is, for example, formed of a light shielding metal, metal oxide, or the like. The inside of the light shielding layer 22, the light shielding layer 26, or the light shielding layer 32 is a display region E in which a plurality of pixels P are arranged. The pixels P have, for example, a substantially rectangular shape and are arranged in a matrix.

The display region E is a region which substantially contributes to the display in the liquid crystal device 1. Here, the liquid crystal device 1 may be provided with a dummy region which is provided so as to surround the periphery of the display region E and which substantially does not contribute to the display.

A data line driving circuit 51 and a plurality of external connecting terminals 54 are provided along a first periphery side on the opposite side to the display region E of the sealing material 42 which is formed along the first periphery side of the element substrate 20. In addition, an inspection circuit 53 is provided on the display region E side of the sealing material 42 along another second periphery side which opposes the first periphery side. Furthermore, a scan line driving circuit 52 is provided inside the sealing material 42 along the other two periphery sides which are orthogonal with the above two periphery sides and oppose each other.

A plurality of wirings 55 which connect two scan line driving circuits 52 are provided on the display region E side of the sealing material 42 of the second periphery side where the inspection circuit 53 is provided. The wiring which is connected to the data line driving circuit 51 or the scan line driving circuit 52 is connected with a plurality of external connecting terminals 54. In addition, vertical conduction sections 56 for creating electrical conduction between the element substrate 20 and the counter substrate 30 are provided in four corners of the counter substrate 30. Here, the arrangement of the inspection circuit 53 is not limited to this configuration and the inspection circuit 53 may be provided at a position along the inside of the sealing material 42 between the data line driving circuit 51 and the display region E.

In the description below, a direction along the first periphery side where the data line driving circuit 51 is provided is set as a first direction (an X direction) and a direction which is orthogonal with the first periphery side is set as a second direction (a Y direction). The X direction is a direction which is in parallel with line III-III in FIG. 1. In addition, a direction which intersects orthogonally with the X direction and the Y direction and toward the upper part in FIG. 1 is set as a Z direction. In the present specification, the view from a normal line direction (the Z direction) of the counter substrate 30 side surface of the liquid crystal device 1 is referred to as a “plan view”.

A light shielding layer 22a and a light shielding layer 26a (refer to FIG. 3) are provided in a grid pattern in the boundary section of each of the pixels P so as to planarly partition the pixels P in the display region E. In summary, black matrixes along the X direction and the Y direction are provided in a grid pattern in the element substrate 20 by the light shielding layer 22a and the light shielding layer 26a. In this manner, the pixels P are partitioned in a grid pattern by the black matrixes formed of the light shielding layer 22a and the light shielding layer 26a and a region which does not overlap with the light shielding layer 22a and the light shielding layer 26a in plan view in the pixels P is an opening region (an optical modulation section) in the pixels P.

As shown in FIG. 2, in the display region E, a scan line 2 and a data line 3 are formed so as to intersect with each other and the pixels P are provided in correspondence with the intersection between the scan line 2 and the data line 3. A pixel electrode 28 and a TFT 24, which is a switching element, are provided in each of the pixels P.

One of source drains of the TFT 24 is electrically connected with the data line 3 which extends from the data line driving circuit 51. Image signals S1, S2, . . . , Sn are supplied from the data line driving circuit 51 (refer to FIG. 1) to the data line 3. A gate of the TFT 24 is electrically connected with a portion of the scan line 2 which extends from the scan line driving circuit 52. Scan signals G1, G2, . . . , Gm are supplied from the scan line driving circuit 52 to the scan line 2. The other source drain of the TFT 24 is electrically connected with the pixel electrode 28.

The image signals S1, S2, . . . , Sn are written in the pixel electrode 28 via the data line 3 at a predetermined timing by setting the TFT 24 to an on state only in a set period. A storage capacitor 5 is formed between a capacitor line 4 which is formed along the scan line 2 and the pixel electrode 28 in the pixel P in order to maintain the image signals S1, S2, . . . , Sn which are supplied to the pixel electrode 28. The storage capacitor 5 is arranged to line up with a liquid crystal capacitor. Thus, when a voltage which corresponds to the image signals S1, S2, . . . , Sn is applied to the liquid crystal 40 of each of the pixels P, the oriented state of the liquid crystal 40 changes due to the applied voltage, light which is incident on the liquid crystal 40 is modulated, and it is possible to display gradations.

As shown in FIG. 3, the liquid crystal device 1 has the element substrate 20 and the counter substrate 30, and the counter substrate 30 is further provided with a microlens array 10, a light path length adjusting layer 31, the light shielding layer 32, a protective layer 33, a common electrode 34, and an oriented film 35. Here, cross-sections for five pixels are drawn in FIG. 3 in order to make the description easy to understand.

The microlens array 10 is provided with a first transparent material 11 and a second transparent material 13. The first transparent material 11 and the second transparent material 13 are light transmitting materials which have different refractive indexes from each other.

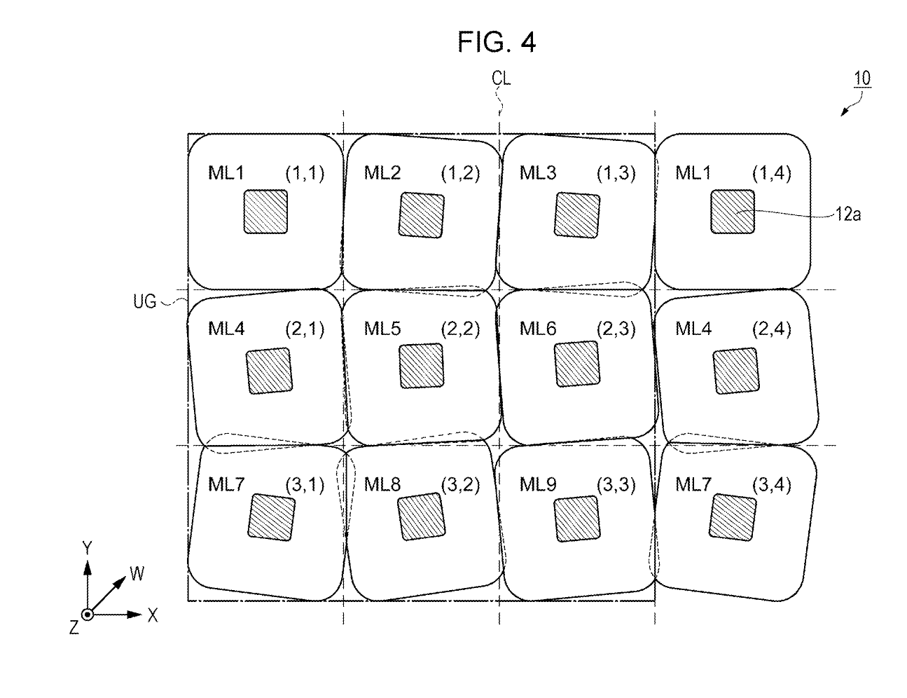

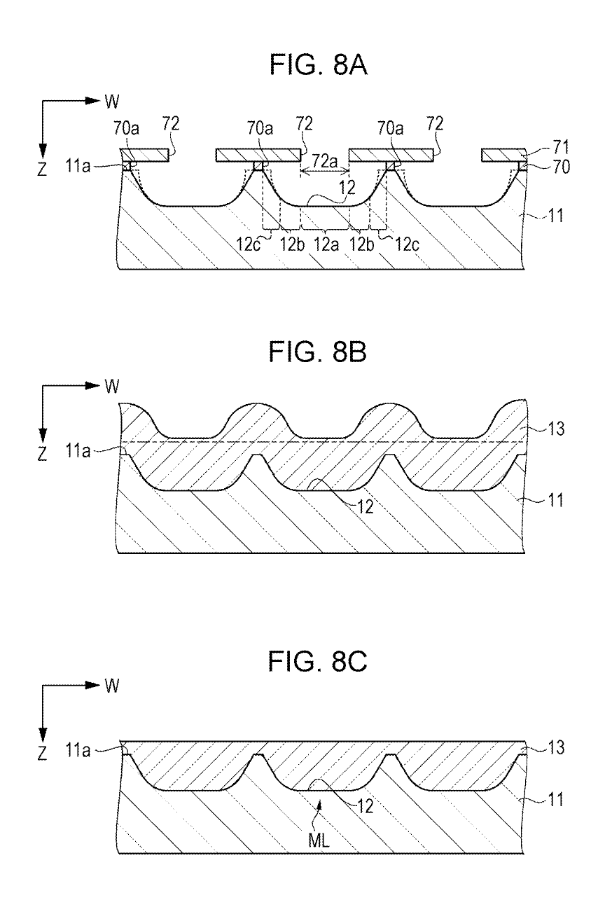

The first transparent material 11 is formed of an inorganic material which has a light transmitting property such as a silicon oxide film (SiO_{X}, X is a value of 1 or 2). Since the silicon oxide film is harmless, excellent in transparency, and easily manufactured and processed, it is possible for the first transparent material to be a material which is harmless, excellent in translucency, and easily manufactured and processed. The refractive index of the silicon oxide film which forms the first transparent material 11 is in a range from 1.46 to 1.50. In the present embodiment, the first transparent material 11 is a quartz substrate and is the substrate of the counter substrate 30. When a surface on the liquid crystal 40 side of the first transparent material 11 is set as an upper surface 11a, a plurality of concave portions 12 are formed from the upper surface 11a of the first transparent material 11 and the surfaces of the concave portions 12 are a portion of the interface between the first transparent material 11 and the second transparent material 13. Each of the concave portions 12 configures a cell CL (refer to FIG. 4) of the microlens array 10 and the cells CL are provided in correspondence with the pixels P in the electro-optical device. The light shielding layer 22a and the light shielding layer 26a (the black matrixes with a grid pattern along the X direction and the Y direction) which are formed on the element substrate 20 cover a boundary of the cell CL of the microlens array 10 in plan view. The concave portion 12 has a flat portion 12a which is arranged in the central portion thereof and a curved surface section 12b and a periphery section 12c which are arranged in the periphery of the flat portion 12a (refer to FIGS. 8A to 8C).

The second transparent material 13 is formed so as to cover the first transparent material 11 and fill the concave portion 12. The second transparent material 13 is formed of a material which has a light transmitting property and a different refractive index from the first transparent material 11. In more detail, the second transparent material 13 is formed of an inorganic material which has a higher refractive index than the first transparent material 11. Examples of such an inorganic material include a silicon oxynitride film (SiON), a silicon nitride film (SiN), an alumina film (Al₂O₃), and the like and a preferable refractive index thereof is approximately 1.60. Since the silicon oxynitride film or the silicon nitride film are harmless, excellent in transparency, and easily manufactured and processed, it is possible for the second transparent material to be a material which is harmless, excellent in transparency, and easily manufactured and processed. In the present embodiment, the silicon oxynitride film is used as the second transparent material 13. A microlens ML with a convex shape is configured by the concave portions 12 being filled with the second transparent material 13. Detailed description will be given below of a method for manufacturing the microlens ML.

The second transparent material 13 is formed to be thicker than the depth of the concave portion 12 and the surface of the second transparent material 13 is a substantially flat surface. That is, the second transparent material 13 has a portion which configures the microlens ML by filling the concave portions 12 and a portion which fulfills a role of a planarizing layer which covers the upper surface of the first transparent material 11 and the surface of the microlens ML. The flat surface of the second transparent material 13 and the flat portion 12a of the concave portion 12 are substantially parallel. Here, in a case of using the wording “substantially parallel”, “substantially matched”, “substantially equal”, or the like in the present specification, these have meanings of being in parallel in terms of the design concept, being matched in terms of the design concept, being equal in terms of the design concept, and the like and cases of being different due to errors in manufacturing, errors in measurement, minute differences, or the like are also included in the above.

The light path length adjusting layer 31 is provided so as to cover the microlens array 10. The light path length adjusting layer 31 has a light transmitting property and is, for example, formed of an inorganic material which has substantially the same refractive index as the first transparent material 11. The light path length adjusting layer 31 is set to adjust a distance from the microlens ML to the light shielding layer 26a and such that light which is concentrated in the microlens ML passes through the opening region of the pixel P without being shielded by the light shielding layer 26a or the light shielding layer 22a. Accordingly, the thickness of the light path length adjusting layer 31 is appropriately set based on optical conditions such as a focal point distance of the microlens ML according to the wavelength of light.

The light shielding layer 32 is provided on the light path length adjusting layer 31 (the liquid crystal 40 side). The light shielding layer 32 is formed in a frame shape so as to overlap the light shielding layer 22 and the light shielding layer 26 of the element substrate 20 in plan view. The region which is surrounded by the light shielding layer 32 (the display region E) is a region in which it is possible for light to be transmitted. Here, a light shielding layer which is not shown in the diagram and using the same material as the light shielding layer 32 may be further provided on the light path length adjusting layer 31 which overlaps the light shielding layer 22a and the light shielding layer 26a in plan view. The light shielding layer which is not shown in the diagram is arranged in corners of each of the pixels P or in the periphery of each of the pixels P, reflects light, which falls on the light shielding layer 22a or the light shielding layer 26a on the element substrate 20 side without being completely concentrated in the microlens ML, on the counter substrate 30 side and has an effect that prevents increases in the temperature of the liquid crystal device 1.

The protective layer 33 is provided so as to cover the light path length adjusting layer 31 and the light shielding layer 32. The common electrode 34 is provided so as to cover the protective layer 33. The common electrode 34 is formed over a plurality of the pixels P. The common electrode 34 is, for example, formed of a transparent conductive film such as indium tin oxide (ITO) or indium zinc oxide (IZO). The oriented film 35 is provided so as to cover the common electrode 34.

Here, the protective layer 33 covers the light shielding layer 32 and planarizes the liquid crystal 40 side surface of the common electrode 34, but is not an essential constituent element. Accordingly, for example, the configuration may be a configuration in which the common electrode 34 directly covers the conductive light shielding layer 32.

The element substrate 20 is provided with a substrate 21, the light shielding layer 22, the light shielding layer 22a, an insulation layer 23, the TFT 24, an insulation layer 25, the light shielding layer 26, the light shielding layer 26a, an insulation layer 27, the pixel electrode 28, and an oriented film 29. The substrate 21 is, for example, formed of a material which has a light transmitting property such as glass or quartz.

The light shielding layer 22 and the light shielding layer 22a are provided on the substrate 21. The light shielding layer 22 is formed in a frame shape so as to overlap the light shielding layer 26 on the upper layer in plan view. The light shielding layer 22a and the light shielding layer 26a are arranged so as to interpose the TFT 24 therebetween in the thickness direction (the Z direction) of the element substrate 20. The light shielding layer 22a and the light shielding layer 26a overlap with at least a channel forming region and a drain end of the TFT 24 in plan view. By the light shielding layer 22a and the light shielding layer 26a being provided, the incidence of light on the TFT 24 is suppressed. The region which is surrounded by the light shielding layer 22a and the light shielding layer 26a in plan view is an opening region of the pixel P and is a region in which light is transmitted in the pixel P.

The insulation layer 23 is provided so as to cover the substrate 21, the light shielding layer 22, and the light shielding layer 22a. The insulation layer 23 is, for example, formed of an inorganic material such as SiO₂.

The TFT 24 is provided on the insulation layer 23. The TFT 24 is a switching element which drives the pixel electrode 28. The TFT 24 includes a semiconductor layer, a gate electrode, a source electrode, and a drain electrode which are not shown in the diagram. A source, a channel forming region, and a drain are formed in the semiconductor layer. A lightly doped drain (LDD) region may be formed in the interface between the channel forming region and the source or between the channel forming region and the drain.

The gate electrode is formed in the element substrate 20 in the region which overlaps with the channel forming region of the semiconductor layer in plan view via a portion of the insulation layer 25 (a gate insulation film). Although omitted from the diagram, the gate electrode is electrically connected with a scan line which is arranged on the lower layer side via a contact hole and controls the TFT 24 to be on or off by applying a scan signal.

The insulation layer 25 is provided so as to cover the insulation layer 23 and the TFT 24. The insulation layer 25 is, for example, formed of an inorganic material such as SiO₂. The insulation layer 25 includes a gate insulation film which insulates between the semiconductor layer and the gate electrode of the TFT 24. Due to the insulation layer 25, surface unevenness caused by the TFT 24 is eased. The light shielding layer 26 and the light shielding layer 26a are provided on the insulation layer 25. Then, the insulation layer 27 formed of an inorganic material is provided so as to cover the insulation layer 25, the light shielding layer 26, and the light shielding layer 26a.

The pixel electrode 28 is provided for each pixel P on the insulation layer 27. The pixel electrode 28 is arranged so as to overlap the opening region of the pixel P in plan view and the edge section of the pixel electrode 28 overlaps with the light shielding layer 22a or the light shielding layer 26a. The pixel electrode 28 is, for example, formed of a transparent conductive film such as ITO or IZO. The oriented film 29 is provided so as to cover the pixel electrode 28. The liquid crystal 40 is held between the oriented film 29 of the element substrate 20 and the oriented film 35 of the counter substrate 30.

Here, the TFT 24 and an electrode, a wiring, or the like (which is not shown in the diagram) which supplies an electrical signal to the TFT 24 are provided in a region which overlaps the light shielding layer 22 or the light shielding layer 22a and the light shielding layer 26 or the light shielding layer 26a in plan view. The configuration may be a configuration in which the electrode, the wiring, or the like serves as the light shielding layer 22 or the light shielding layer 22a and the light shielding layer 26 or the light shielding layer 26a.

In the liquid crystal device 1 according to Embodiment 1, for example, light which is emitted from a light source or the like is incident from the counter substrate 30 side which is provided with the microlens ML and is concentrated by the microlens ML. Out of light which is incident on the microlens ML along a normal line direction of the upper surface 11a from the first transparent material 11 side, incident light L1 which is incident on the central portion of the microlens ML in plan view (the flat portion 12a of the concave portion 12) goes straight through the microlens ML as is, passes through the liquid crystal 40, and is output to the element substrate 20 side.

On the other hand, incident light L2 which is incident on the surrounding section of the microlens ML in plan view (a region which includes a region which overlaps with the light shielding layer 22a or the light shielding layer 26a in plan view) is shielded by the light shielding layer 26 or the light shielding layer 26a as shown with a dashed line in FIG. 3, if in a case of going straight as is. However, in the electro-optical device of the present embodiment, the incident light L2 which is incident on the surrounding section is also concentrated to the planar central side of the pixel P in the microlens ML (refraction due to the refractive index difference between the first transparent material 11 and the second transparent material 13). In the liquid crystal device 1, the light incident on the boundary section (the boundary section of the pixels P) between microlenses ML is also made to be incident inside the opening region of the pixel P due to a concentration effect in the boundary section in this manner and is able to pass through the liquid crystal 40. As a result, the amount of light which is output from the element substrate 20 side increases and the light utilization efficiency is increased.

### Microlens

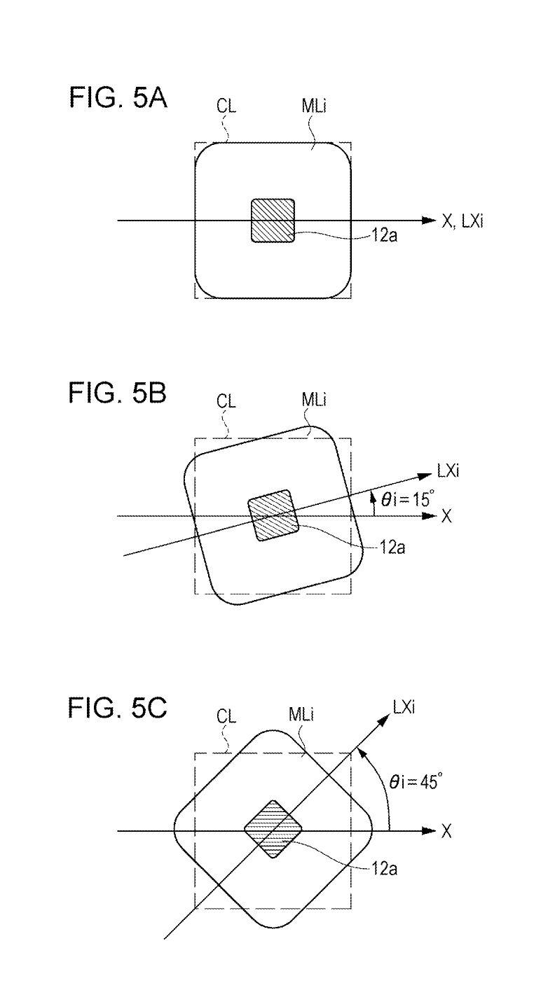

FIG. 4 is a planar diagram which illustrates a configuration of the microlens array according to Embodiment 1. FIGS. 5A to 5C are planar diagrams which illustrate the microlens according to Embodiment 1. Subsequently, description will be given of the configuration and action of the microlens ML with which the microlens array 10 according to Embodiment 1 is provided with reference to FIG. 4 and FIGS. 5A to 5C.

The microlens array 10 is provided with a plurality of cells CL and the plurality of the cells CL are arranged in a matrix such that the cells CL which are adjacent in the X direction and the Y direction come into contact with each other. When the microlens array 10 is applied to an electro-optical device, one cell CL of the microlens array 10 and one pixel P of the electro-optical device are aligned in plan view. In summary, the size of the one cell CL which configures the microlens array 10 and the position thereof in plan view match the size of the one pixel P of the electro-optical device and the position thereof in plan view in terms of the design concept. That is, apart from manufacturing errors, the size of the cell CL and the position thereof in plan view match the size of the pixel P and the position thereof in plan view. Twelve cells CL in 3 rows and 4 lines which configure the microlens array 10 are drawn in FIG. 4. Here, in order to facilitate understanding of the description below, the names of each of the cells CL are set as (1,1), (1,2), (1,3), (1,4), (2,1), (2,2), (2,3), (2,4), (3,1), (3,2), (3,3), and (3,4) in FIG. 4. In addition, although not shown in FIG. 4, in a case in which the microlens array 10 is assembled in the electro-optical device, the light shielding layer 22a or the light shielding layer 26a is arranged in the element substrate 20 so as to be along the boundary of the cells CL which are adjacent in the X direction and the Y direction.

As shown in FIG. 4, the cell CL has a polygonal planar shape. The cell CL is a quadrilateral and a square in the present embodiment; however, the cell CL may be a rectangle or may be a triangle or a hexagon. The planar shape of the cell CL is able to be matched with the planar shape of the pixel P. A polygonal microlens ML is arranged in each of the cells CL. That the microlens ML is a polygon has a meaning that each of the microlenses ML is able to be similar to a polygon which has a plurality of straight line boundaries when a portion in an arc shape which is formed in the corner section of the microlens ML is ignored. In the present embodiment, the microlens ML is a quadrilateral which is close to a square.

Each of the microlenses ML has the flat portion 12a substantially in the central portion thereof and the flat portion 12a is a polygon in plan view. The flat portion 12a is smaller than the cell CL and is a polygon which is approximately similar to the microlens ML and the angle between at least one side which forms the cell CL (for example, a side of the cell CL which extends in the X direction) and at least one side which forms the flat portion 12a (in the case of the present example, a side which extends approximately in the X direction in the flat portion 12a) is within a range from −15° to +15°. In this manner, since it is possible to make a shape of the microlens ML in plan view and a shape of the cell CL approximately uniform apart from the cell corner section, the microlens array 10 with high light utilization efficiency is realized. That is, it is possible to reduce a region in which the microlens ML is not formed inside the cell CL. The flat portion 12a is a quadrilateral and a square in the present embodiment. In addition, the center of the cell CL in plan view (the barycenter of the planar shape body of the cell CL) and the center of the flat portion 12a in plan view (a barycenter of the planar shape body of the flat portion 12a) are substantially matched.

A non-lens section, a cylindrical lens, and a spherical lens are arranged in the cell CL. In detail, the non-lens section is formed in the flat portion 12a, the cylindrical lens is formed in a region along the side of the flat portion 12a in the outside of the flat portion 12a, and the spherical lens is formed in a region outside the corner section of the flat portion 12a. As shown in FIG. 3, the incident light which is incident on the flat portion 12a and in parallel with the normal line of the cell CL is substantially straight as is. The light path of the incident light which is incident on the cylindrical lens and in parallel with the normal line of the cell CL is bent to the flat portion 12a side by the cylindrical lens. The cylindrical lens is a lens which converges or disperses incident light by having refractive power in one direction and which does not have refractive power in the other direction which intersects orthogonally with this direction. Accordingly, the lens surface in a lens cross-section along one direction changes to have a curvature; however, the lens surface is a straight line in a lens cross-section along the cross-section of the other direction which intersects orthogonally with this direction. The light path of the incident light which is incident on the spherical lens and in parallel with the normal line of the cell CL is bent to the flat portion 12a side by the spherical lens. The spherical lens is a convex lens, the thickness of the spherical lens (the thickness of the second transparent material 13) is the maximum at the intersection of the sides of the flat portion 12a, and the spherical lens becomes thinner further from the intersections of the flat portion 12a.

As shown in FIG. 4, the microlens array 10 has a unit cell group UG. M×N (M is an integer of for more and N is an integer of 2 or more) of the microlenses ML are arranged in the unit cell group UG. In the present embodiment, as an example, nine microlenses ML are arranged in the unit cell group UG by setting M=N=3. In detail, a first lens ML1 is arranged in the cell (1,1), a second lens ML2 is arranged in the cell (1,2), a third lens ML3 is arranged in the cell (1,3), a fourth lens ML4 is arranged in the cell (2,1), a fifth lens ML5 is arranged in the cell (2,2), a sixth lens ML6 is arranged in the cell (2,3), a seventh lens ML7 is arranged in the cell (3,1), an eighth lens ML8 is arranged in the cell (3,2), and a ninth lens ML9 is arranged in the cell (3,3). One unit cell group UG is configured by these M×N microlenses ML. Then, the microlens array 10 is formed by the unit cell group UG being repeatedly arranged in the first direction or the second direction. In FIG. 4, since the unit cell group UG is repeatedly arranged in the first direction (the X direction), the first lens ML1 is arranged in the cell (1,4), the fourth lens ML4 is arranged in the cell (2,4), and the seventh lens ML7 is arranged in the cell (3,4).

For the first lens ML1 and the second lens ML2 which are arranged in the unit cell group UG, the direction of the first lens ML1 in plan view (the first lens direction) and the direction of the second lens ML2 in plan view (the second lens direction) are different. As shown in FIG. 4, it is ideal if the directions of the M×N lenses which are arranged in the unit cell group UG in plan view are all different. In this manner, since it is possible to suppress diffraction caused by the regularity of the lenses, it is possible to realize a microlens array with high light utilization efficiency.

Next, description will be given regarding the directions of the lenses with reference to FIGS. 5A to 5C. The microlens ML in the present embodiment has the polygonal flat portion 12a and the outer peripheral shape of the microlens ML is a polygon which is approximately similar to the flat portion 12a. As shown in FIGS. 5A to 5C, the direction of one side which configures the cell CL is set as the first direction (the X direction) and a direction of a side where the angle made with the first direction (the X direction) by a side of the flat portion 12a of the microlens ML (the i-th lens MLi) inside the cell CL is close to zero is set as a lens direction LXi. The angle of the direction of the i-th lens MLi (i is an integer of 1 to M×N) in plan view (the i-th lens direction LXi) with respect to the first direction is set as the i-th lens angle θi. For example, the angle of the first lens direction with respect to the first direction is the first lens angle θ1 and the angle of the second lens direction with respect to the first direction is the second lens angle θ2. FIG. 5A shows θi=0° and the lens direction LXi and the first direction (the X direction) are in parallel. FIG. 5B shows θi=15° and the lens direction LXi and the first direction (the X direction) have an angle of 15°. FIG. 5C is θi=45° and the lens direction LXi and the first direction (the X direction) have an angle of 45°. In the present embodiment, since the flat portion 12a is a square, the lens direction LXi and the first direction (the X direction) may have an angle in a range from −45° to +45°.

Each of the M×N of the microlenses which are arranged in the unit cell group UG is arranged such that the angle between the lens direction LX and the first direction (the X direction) is in a range from −15° to +15°. Therefore, the first lens angle θ1 and the second lens angle θ2 are both in a range from −15° to +15°. In this manner, since it is possible to reduce a region in which the microlens ML is not arranged inside the cell CL, it is possible to efficiently concentrate incident light which is incident on the cell. In the present embodiment, the first lens angle θ1 to the ninth lens θ9 are all different values and these are all within a range from −15° to +15°. As specific examples, as shown in FIG. 4, θ1=0° (the first lens ML1), θ2=−5° (the second lens ML2), θ3=−2° (the third lens ML3), θ4=+2° (the fourth lens ML4), θ5=+1° (the fifth lens ML5), θ6=+4° (the sixth lens ML6), θ7=−10° (the seventh lens ML7), θ8=+10° (the eighth lens ML8), and θ9=+6° (the ninth lens ML9).

According to diligent research by the present inventors, the reason that the light utilization efficiency is low in an electro-optical device which uses the microlens of the related art is described as below. That is, in an electro-optical device which uses the microlens array described in JP-A-2004-70282, since the arrangement of the pixel and the microlens has regularity (periodicity), diffraction caused by the regularity of the pixels or the microlenses occurred. The diffraction is a phenomenon which is generated when a light wave passes through a light shielding body or a refractive index body which has a periodic structure and a phenomenon in which strength differences are seen in the light due to interference of the light waves which are spread by the diffraction. A two-dimensional Fourier transform is carried out on the light wave which passes through the periodic structure and the light wave is projected as a Fraunhofer diffraction to infinity. A projected image of a degree m appears at the angle αm where sin αm=λ(m/a) is satisfied. Here, a is a period of the periodic structure and λ is the wavelength of the light wave. For this reason, the angle αm where the projected image appears when the periodic structure a is small becomes large and the projected image of the degree thereof is far from the 0 degree spot. Therefore, when the periodic structure a is small, in other words, when the pixel size is small, the spreading of the light due to the diffraction is large.

Along with increases in the level of high definition in electro-optical devices, there is a demand that the size of the pixels P be reduced to 4 microns (μm) to 6 microns (μm). In a case in which the pixels are reduced to this extent, it is not possible to ignore the influence of diffraction. In electro-optical devices in the related art, the rays which enter the electro-optical device firstly interfere with the microlens array, further interfere with the pixel, and enter the projector lens with an appropriate diffraction pattern. At this time, the smaller the pixel is, the larger the spreading angle of the luminous flux due to the interference is and the relationship with the F value of the projector lens becomes significant. Since the projector lens is able to handle the microlens array and the pixel as an infinite distance, the diffraction pattern spreads with a component of the angle αm. It is possible to consider that at this time, the ratio of the light at an angle, which does not belong to the angle range regulated by the F value of the projector lens, increases and that the brightness decreases.

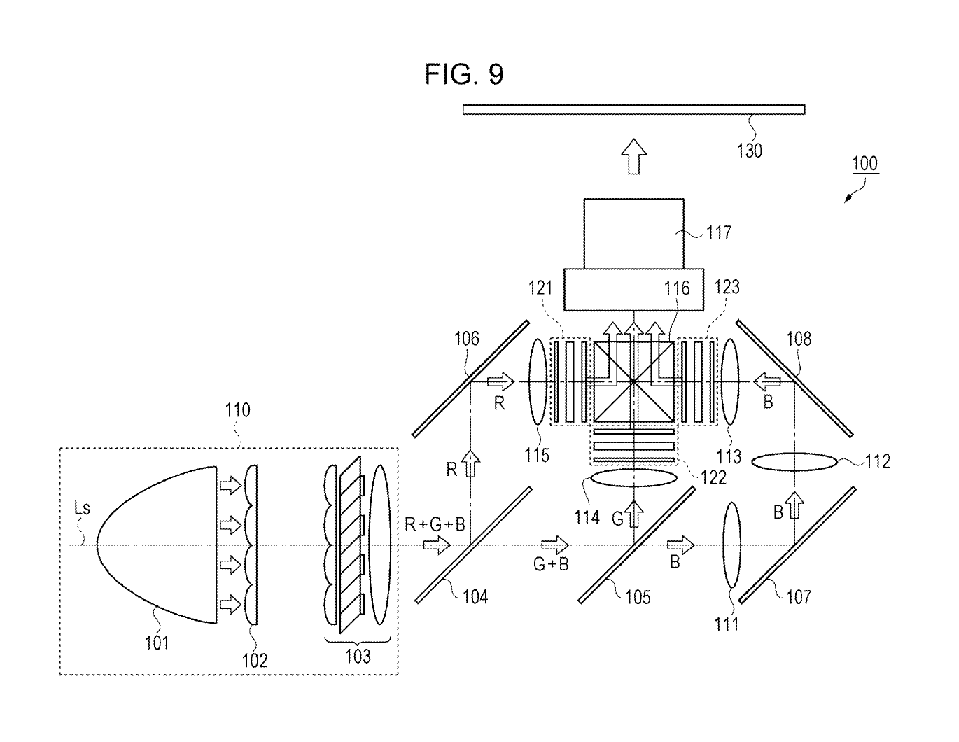

Thus, in the microlens array 10 of the present embodiment, as shown in FIG. 4, the directions of the M×N lenses which are arranged in the unit cell group UG in plan view are set to be different. Due to this, the shapes of the microlens ML inside the unit cell group UG are different and at least the interference due to the microlens ML inside the unit cell group UG is suppressed to a certain extent. That is, in the microlens array 10 which is used for an electro-optical device which corresponds to small pixels P of 10 microns (μm) or less where the size is from 4 microns (μm) to 6 microns (μm), in order to suppress diffraction caused by the adjacent cells CL, each of the microlenses ML inside the unit cell group UG is changed such that the periodic structure (the size of the unit cell group UG) is several pixels (several cells) or more. In this manner, since the periodic structure due to the microlens array 10 is a plurality of the cells CL, the value of the periodic structure a is greater and the diffraction spots are gathered in the vicinity of 0 degree light (the incident light direction). That is, the ratio of the light at an angle which belongs to the angle range regulated by the F value of a projector lens 117 (refer to FIG. 9) increases and the brightness improves.

### Cell Arrangement in Display Region

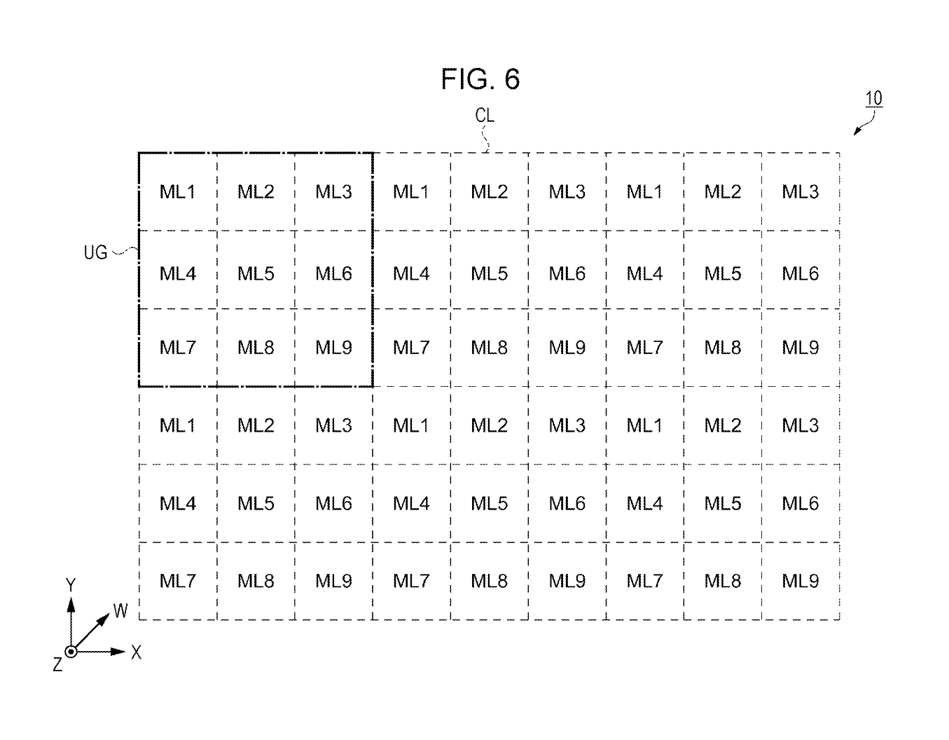

FIG. 6 is a diagram which illustrates a planar cell arrangement of the microlens array according to Embodiment 1. Next, description will be given of the configuration regarding the arrangement of the cells CL of the microlens array 10 according to Embodiment 1 with reference to FIG. 6.

In order to suppress diffraction caused by regularity of the cells CL, it is preferable that the period of the regularity caused by the microlens ML be sufficiently greater than the wavelength. Ideally, the period of the regularity caused by the microlens ML is set to be approximately 100 times or more the wavelength of the light. In this manner, the diffraction caused by the regularity of the microlens ML is remarkably suppressed. In other words, it is ideal if the microlenses ML of the cells CL which configure the microlens array 10 are all different in a range within approximately 100 times the wavelength. That the cells CL are different has the meaning that each of the shapes (in the lens direction) of the microlenses ML which configure the cell CL is unique. In the present embodiment, since the light is assumed to be mainly visible light, it is ideal if the microlens ML does not have regularity within a range from approximately 70 microns (μm) in order to suppress the interference of the visible light. On the other hand, in an electro-optical device, since there is also a case in which the size of the pixel P (the cell CL) is as small as approximately 7 microns (μm), it is possible to say in this case that it is ideal if all the microlenses ML are different inside a unit of approximately 10 cells×10 cells. In detail, by setting the square of n (n²) cells CL as the unit cell group UG, the square of n (n²) microlenses ML are all different in the unit cell group UG (the lens shapes are all different in the square of n (n²) cells CL). Then, the microlens array 10 is configured by repeating the unit cell group UG. In this case, n is in a range from 2 to 20 and it is ideal if n is approximately 10.

When n is set to 10, it is necessary to form 100 different types of the microlenses ML; however, this is not easy. Thus, in the present embodiment, as shown in FIG. 6, 9 different types of the microlenses ML from the first lens ML1 to the ninth lens ML9 are prepared as the microlenses ML and the group which includes these 9 types of the microlenses ML is set as the unit cell group UG and repeated in the X direction and the Y direction to set the microlens array 10. An example of the first lens ML1 to the ninth lens ML9 is as drawn in the center in FIG. 4. In FIG. 6, 54 cells CL in 6 rows 9 lines are shown as an example and 6 unit cell groups are visible. In this manner, diffraction caused by the regularity of the cell CL is suppressed and the light utilization efficiency improves.

### Method for Manufacturing an Electro-Optical Device

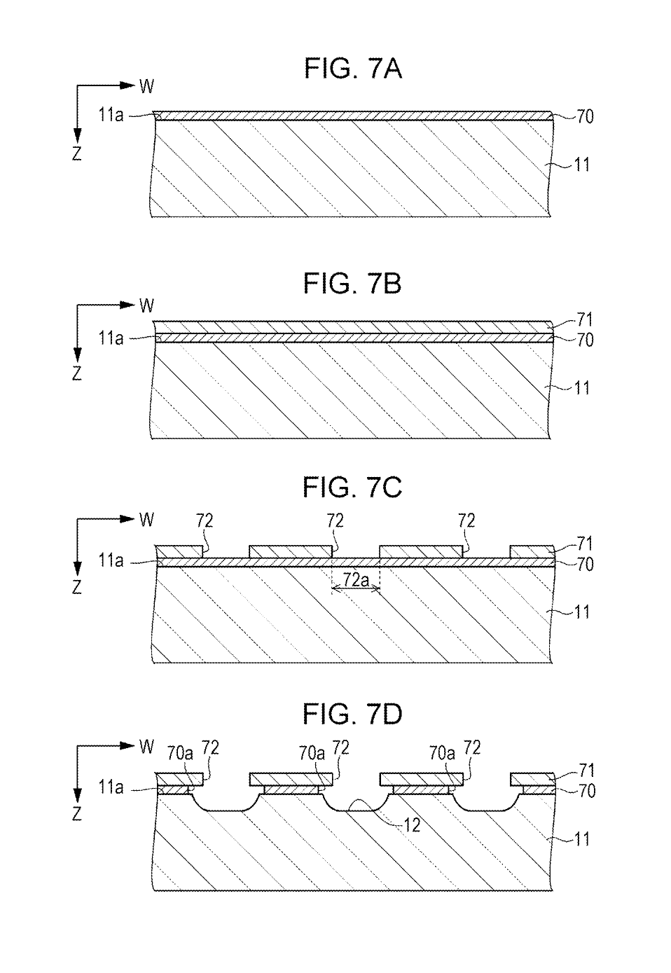

FIGS. 7A to 7D are schematic cross-sectional diagrams which show a method for manufacturing the microlens array according to Embodiment 1. FIGS. 8A to 8C are schematic cross-sectional diagrams which show a method for manufacturing the microlens array according to Embodiment 1. Next, description will be given of a method for manufacturing the liquid crystal device 1 which has the microlens array 10 according to Embodiment 1 with reference to FIGS. 7A to 7D and FIGS. 8A to 8C. Here, in FIGS. 7A to 7D and FIGS. 8A to 8C, in order to facilitate understanding of the description, a cross-sectional diagram is drawn which corresponds to three microlenses ML when the microlens array 10 is completed. In addition, although not shown in the diagram, in the process of manufacturing the microlens array 10, processing is performed on a large substrate (a mother substrate) which is able to take a plurality of microlens arrays 10 and the plurality of the microlens arrays 10 are obtained by finally cutting and individuating the mother substrate. Accordingly, the processing is performed in a state before the mother substrate is individuated in each of the processes described below; however, here, description will be given of processing with respect to the individual microlens array 10 in the mother substrate.

Firstly, a process of forming the first transparent material 11 on a substrate is performed. In the present embodiment, since a quartz substrate serves as a portion of the first transparent material 11, this process is a process of preparing the quartz substrate and, as shown in FIG. 7A, a process of forming a control film 70 formed of a silicon oxide film or the like on the upper surface 11a of the first transparent material 11. The control film 70 has a different etching rate from the quartz substrate when forming the concave portion 12 and has a function of adjusting the etching rate in the width direction (the W direction) with respect to the etching rate in the depth direction (the Z direction) when forming the concave portion 12. When the etching rate of the control film 70 is fast, the curved surface section 12b is small, the periphery section 12c is large, and the inclination with respect to the upper surface 11a of the periphery section 12c is gentle. When the etching rate of the control film 70 is the same as the quartz substrate, since the periphery section 12c disappears and the curved surface section 12b in an arc shape intersects orthogonally with the upper surface 11a, it is desired that the etching rate of the control film 70 be slower than the etching rate of the quartz substrate. This is because in this manner, the incident light L2 which is incident on the periphery section 12c is bent in the direction to the center of the cell CL.

After forming the control film 70, annealing of the control film 70 is performed at a predetermined temperature. The etching rate of the control film 70 changes according to the temperature during the annealing. Accordingly, it is possible to adjust the etching rate of the control film 70 by appropriately setting the temperature during the annealing.

Next, as shown in FIG. 7B, a process of forming a mask layer 71 which has an opening portion in the unit region on the control film 70 of the first transparent material 11 proceeds. The unit region is a region which is a cell CL when the microlens array 10 is completed. The mask layer 71 is, for example, formed of polycrystal silicon or the like on the upper surface of the first transparent material 11. The polycrystal silicon which forms a mask layer is, for example, accumulated by a chemical vapor deposition method (CVD), a physical vapor deposition method (for example, a sputtering method or the like), or the like. Subsequently, as shown in FIG. 7C, a photolithography method and a dry etching process are carried out on the accumulated thin films and the mask layer 71 which has an opening portion 72 is formed. The opening portion 72 is the same planar shape as the flat portion 12a in plan view when the microlens array 10 is completed. That is, the shape of the opening portion 72 in plan view is the same as the shape of the flat portion 12a in plan view apart from manufacturing errors. Accordingly, the opening portion 72 is a polygon in plan view. In addition, the opening portion 72 has a first opening portion and a second opening portion and the direction of the first opening portion in plan view is different from the direction of the second opening portion in plan view.

Next, as shown in FIG. 7D, by carrying out the isotropic etching on the control film 70 and the first transparent material 11 via the mask layer, a process of forming the concave portion 12 on the control film 70 and the first transparent material 11 proceeds. That is, for example, an isotropic etching process such as wet etching which uses an etchant such as a hydrofluoric acid solution is carried out on the first transparent material 11 via the mask layer. A material for which the etching rate of the control film 70 is larger than the etching rate of the first transparent material 11 as described above is used for the etchant. Due to the etching process, the first transparent material 11 is isotropically etched from the upper surface side by setting the opening portion 72 as a center. As a result, the concave portion 12 is formed in the control film 70 and the first transparent material 11 in correspondence with the opening portion 72. As shown in FIG. 8A, the concave portion 12 is enlarged along with the progress of the isotropic etching and a portion which corresponds to the opening portion 72 of the mask layer 71 in plan view out of the concave portion 12 is a substantially flat surface. Due to this, the flat portion 12a is formed in the central portion of the concave portion 12. In addition, the curved surface section 12b is formed so as to surround the periphery of the flat portion 12a. When the control film 70 is not provided between the first transparent material 11 and the mask layer 71, the curved surface section 12b reaches the upper surface 11a of the first transparent material 11. However, in the present embodiment, the control film 70 is provided between the first transparent material 11 and the mask layer 71 and the etching amount of the control film 70 for each unit of time is more than the etching amount of the first transparent material 11 for each unit of time. Accordingly, since the enlargement amount of an opening portion 70a of the control film 70 is more than the enlargement amount of the concave portion 12 in the depth direction, the width direction of the concave portion 12 is also enlarged along with the enlargement of the opening portion 70a. Therefore, the etching amount of the first transparent material 11 in the width direction for each unit of time is more than the etching amount in the depth direction for each unit of time. Due to this, the periphery section 12c with a tapered shape is formed so as to surround the periphery of the curved surface section 12b.

The curved surface section 12b is provided to continue from the flat portion 12a and has an arc cross-section shape. The curved surface section 12b has a light concentration function as a lens when the microlens ML is completed and light which is incident on the curved surface section 12b along the normal line direction of the upper surface 11a is concentrated to the planar center side of the cell CL. Accordingly, due to the curved surface section 12b, it is possible to make the light, which is incident on the outer side of the central section of the pixel P and which is shielded by the light shielding layer 26 when going straight as is in the electro-optical device, incident inside the opening region of the pixel P.

The periphery section 12c is provided to continue from the curved surface section 12b. The periphery section 12c is connected with the upper surface 11a in the W direction and is connected with the periphery section 12c of the adjacent concave portion 12 in the X direction. The periphery section 12c is an inclined surface which is inclined from the upper surface 11a toward the curved surface section 12b, a surface with a so-called tapered shape. Accordingly, since the light which is incident on the periphery section 12c along the normal line direction of the upper surface 11a when the microlens ML is completed is refracted to the planar center side of the cell CL, it is possible to make the light, which is shielded by the light shielding layer 26 when going straight as is in the electro-optical device, incident inside the opening region of the pixel P.

In addition, when the microlens ML is completed, the periphery section 12c does not have a light concentration function as a lens. Accordingly, since the light which is incident on the periphery section 12c along the normal line direction of the upper surface 11a is refracted at substantially the same angle, it is possible to suppress the variations in the angle of the light which is incident on the liquid crystal 40.

As described above, it is possible to control the shape of the flat portion 12a in the concave portion 12 according to the shape of the opening portion 72 of the mask layer 71. In addition, the respective sizes of the curved surface section 12b and the periphery section 12c in the concave portion 12 are controlled according to the etching rate in the width direction of the first transparent material 11 with respect to the etching rate in the depth direction and it is possible to adjust the difference between the etching rates by setting the temperature during the annealing of the control film 70.

Next, as shown in FIG. 8B, after removing the mask layer 71 from the first transparent material 11, a process of forming the second transparent material 13 which has a higher refractive index than the first transparent material 11 so as to cover the concave portion 12 proceeds. That is, a process of filling the concave portion 12 with the second transparent material 13 which has a refractive index which is different from the refractive index of the first transparent material 11 proceeds. Firstly, the second transparent material 13 formed of an inorganic material which has a light transmitting property and which has a higher refractive index than the first transparent material 11 is film-formed so as to cover the entire region of the first transparent material 11 and fill the concave portion 12. It is possible to form the second transparent material 13, for example, using a CVD method. Since the second transparent material 13 is formed so as to be accumulated on the upper surface of the first transparent material 11, the surface of the second transparent material 13 has an uneven shape in which unevenness caused by the concave portion 12 of the first transparent material 11 is reflected. After accumulating the second transparent material 13, a planarizing process is carried out with respect to the film. In the planarizing process, for example, the upper surface of the second transparent material 13 is planarized by polishing and removing the portion of the upper layer of the second transparent material 13 in which the unevenness is formed using a chemical mechanical polishing method or the like. That is, by polishing and removing the portion above the two dotted line shown in FIG. 8B, the upper surface of the second transparent material 13 is planarized. Thus, as shown in FIG. 8C, the upper layer of the second transparent material 13 is planarized and the microlens array 10 is completed.

Next, using a technique which is known in the art, the counter substrate 30 is obtained by forming the light path length adjusting layer 31, the light shielding layer 32, the protective layer 33, the common electrode 34, and the oriented film 35 in sequence on the microlens array 10. Description will be given of the subsequent processes with reference to FIG. 3, but detailed illustration will be omitted. Meanwhile, the element substrate 20 is obtained by forming the light shielding layer 22, the insulation layer 23, the TFT 24, the insulation layer 25, the light shielding layer 26, the insulation layer 27, the pixel electrode 28, and the oriented film 29 in sequence on the substrate 21.

Next, as the sealing material 42 (refer to FIG. 1), a thermosetting or photocurable adhesive agent is arranged and cured between the element substrate 20 and the counter substrate 30. Due to this, the element substrate 20 and the counter substrate 30 are bonded and the liquid crystal device 1 is completed.

### Electronic Apparatus

Next, description will be given of an electronic apparatus with reference to FIG. 9. FIG. 9 is a schematic diagram which shows a configuration of a projector as an electronic apparatus according to Embodiment 1.

As shown in FIG. 9, the projector (the projection type display apparatus) 100 as the electronic apparatus according to Embodiment 1 is provided with a polarization lighting apparatus 110, two dichroic mirrors 104 and 105, three reflection mirrors 106, 107, and 108, five relay lenses 111, 112, 113, 114, and 115, three liquid crystal light bulbs 121, 122, and 123, a cross dichroic prism 116, and the projector lens 117.

The polarization lighting apparatus 110 is, for example, provided with a lamp unit 101 as a light source formed of a white light source such as an ultrahigh pressure mercury lamp or a halogen lamp, an integrator lens 102, and a polarization conversion element 103. The lamp unit 101, the integrator lens 102, and the polarization conversion element 103 are arranged along a system optical axis Ls.

The dichroic mirror 104 reflects a red light (R) out of the polarization luminous flux which is output from the polarization lighting apparatus 110 and transmits a green light (G) and a blue light (B). The other dichroic mirror 105 reflects the green light (G) which is transmitted through the dichroic mirror 104 and transmits the blue light (B).

The red light (R) which is reflected by the dichroic mirror 104 is incident on the liquid crystal light bulb 121 via the relay lens 115 after being reflected by the reflection mirror 106. The green light (G) which is reflected by the dichroic mirror 105 is incident on the liquid crystal light bulb 122 via the relay lens 114. The blue light (B) which is transmitted through the dichroic mirror 105 is incident on the liquid crystal light bulb 123 via an optical guiding system which is configured by the three relay lenses 111, 112, and 113 and the two reflection mirrors 107 and 108.

The transmission type liquid crystal light bulbs 121, 122, and 123 as optical modulators are respectively arranged to oppose the incident surface for each colored light of the cross dichroic prism 116. The colored light which is incident on the liquid crystal light bulbs 121, 122, and 123 is modulated based on video information (a video signal) and is output toward the cross dichroic prism 116.

The cross dichroic prism 116 is configured by bonding four rectangular prisms and a dielectric multilayer film which reflects the red light and a dielectric multilayer film which reflects the blue light are formed in a cross shape on the inner surface thereof. Light which represents a color image is synthesized by the three colored lights being synthesized by the dielectric multilayer films. The synthesized light is projected on a screen 130 by the projector lens 117 which is a projection optical system and the image is enlarged and displayed.

The liquid crystal device 1 described above is applied to the liquid crystal light bulb 121. The liquid crystal light bulb 121 is arranged by placing an interval between a pair of polarization elements which are arranged in a crossed nicol state on the incident side and the output side of the colored light. The other liquid crystal light bulbs 122 and 123 are the same.

According to the configuration of the projector 100 according to Embodiment 1, it is possible to provide the projector 100 which is bright and of high quality even when a plurality of the pixels P are arranged with high definition since the liquid crystal device 1 which has the microlens ML which is able to efficiently use the incident colored light is provided.

### Embodiment 2

### Form 1 where Unit Cell Group is Different

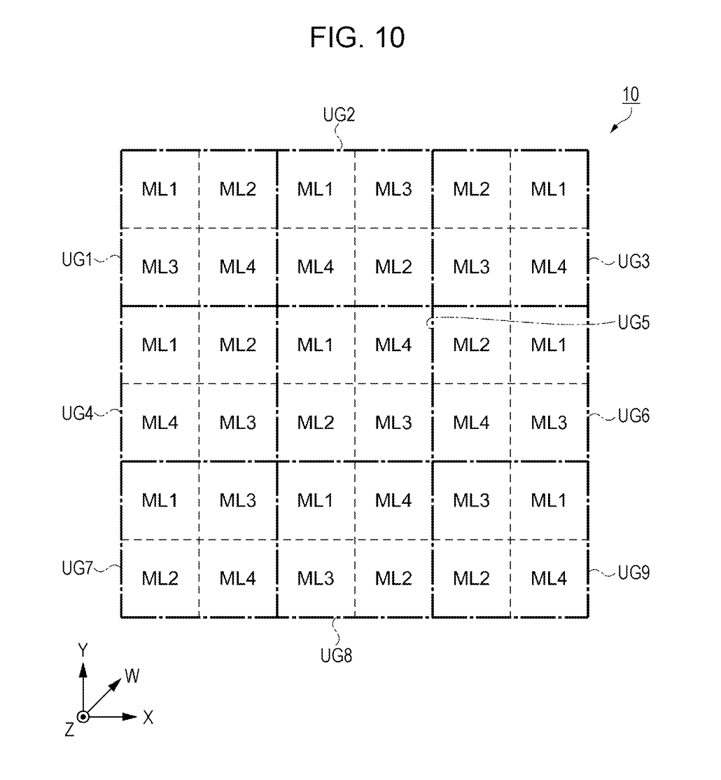

FIG. 10 is a diagram which illustrates an example of a microlens array according to Embodiment 2. Next, description will be given of the microlens array 10 according to Embodiment 2 with reference to FIG. 10. Here, the same reference numbers are used for the same configuration sites as Embodiment 1 and overlapping description will be omitted.

In the microlens array 10 of the present embodiment shown in FIG. 10, the unit cell groups UG which configure the microlens array 10 are different. Other than this, the microlens array 10 of the present embodiment is the same as Embodiment 1. The unit cell group UG in the microlens array 10 of Embodiment 1 shown in FIG. 6 is configured by 9 different microlenses ML and the unit cell group UG is repeatedly arranged. The configuration of the unit cell group UG is not limited thereto and various forms are possible. For example, as shown in FIG. 10, the unit cell group UG includes the square of n of different microlenses ML; however, the arrangement of these microlenses ML may be changed in the unit cell group UG. In the present embodiment, a plurality of types of the unit cell groups UG are prepared and the arrangement of the microlenses ML is changed in each of the unit cell groups UG. For example, as shown in FIG. 10, four different types of microlenses ML from the first lens ML1 to the fourth lens ML4 are prepared and a plurality of types of the unit cell groups UG in which the arrangement of the four types of microlenses ML is changed are made. In the example in FIG. 10, nine types of unit cell groups UG from the first unit cell group UG1 to the ninth unit cell group UG9 are made and the arrangement of the four different types of microlenses ML is changed in each of the unit cell groups UG. For example, the unit cell group UG has the first unit cell group UG1 and the second unit cell group UG2 and the arrangement relationship between the first lens ML1 and the second lens ML2 is different in the first unit cell group UG1 and the second unit cell group UG2. The microlens array 10 may be configured by using a plurality of types of the unit cell groups UG in this manner. In this manner, since the diffraction caused by the microlens array 10 is more strongly suppressed, the light utilization efficiency of the microlens array 10 further improves.

### Embodiment 3

### Form 2 where Unit Cell Group is Different

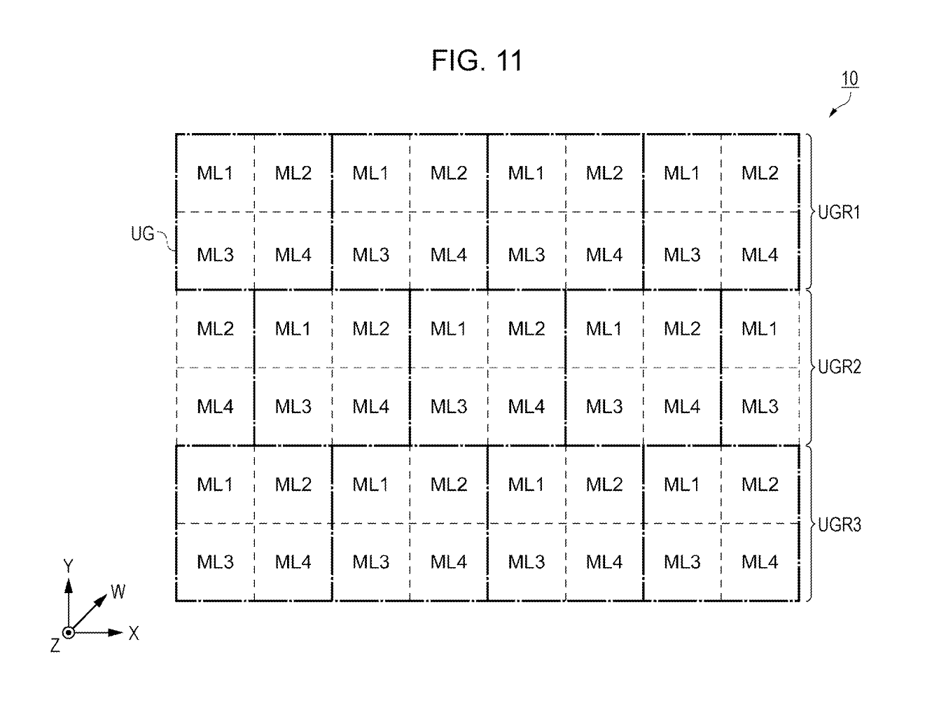

FIG. 11 is a diagram which illustrates an example of a microlens array according to Embodiment 3. Next, description will be given of the microlens array 10 according to Embodiment 3 with reference to FIG. 11. Here, the same reference numbers are used for the same configuration sites as Embodiment 1 and overlapping description will be omitted.

In the microlens array 10 of the present embodiment shown in FIG. 11, the arrangement of the unit cell groups UG which configure the microlens array 10 is different. Other than this, the microlens array 10 of the present embodiment is the same as Embodiment 1. In the microlens array 10 of Embodiment 1 shown in FIG. 6, the unit cell group UG is repeatedly arranged in the X direction and the Y direction. The arrangement of the unit cell group UG is not limited thereto and various forms are possible. For example, as shown in FIG. 11, the unit cell group UG may be arranged by being shifted in each row or line.

As shown by surrounding with a dashed line in FIG. 11, in the microlens array 10, the unit cell groups UG in which 2×2 microlenses formed of the microlenses ML (the first lens ML1, the second lens ML2, the third lens ML3, and the fourth lens ML4) whose lens directions are different from each other are set as a unit ML are repeatedly arranged. In the present embodiment, the unit cell groups UG are arranged by being shifted from each other along the X direction for each row of the adjacent unit cell groups UG. In detail, the odd numbered rows of the unit cell groups UG (the first row UGR1 of the unit cell groups UG, the third row UGR3 of the unit cell groups UG, and the like) and the even numbered rows of the unit cell groups UG (the second row UGR2 of the unit cell groups UG and the like) are arranged by being shifted by one cell along the X direction. In this manner, the arrangement pattern of the repetition of the microlenses ML is doubled every 4 cells regarding the line direction (the Y direction). In this manner, the microlens array 10 in which the unit cell groups UG are arranged by being shifted for each row or line of the unit cell groups UG may be set. In this manner, since the diffraction caused by the microlens array 10 is more strongly suppressed, the light utilization efficiency of the microlens array 10 further improves.

### Embodiment 4

### Form 3 where Unit Cell Group is Different

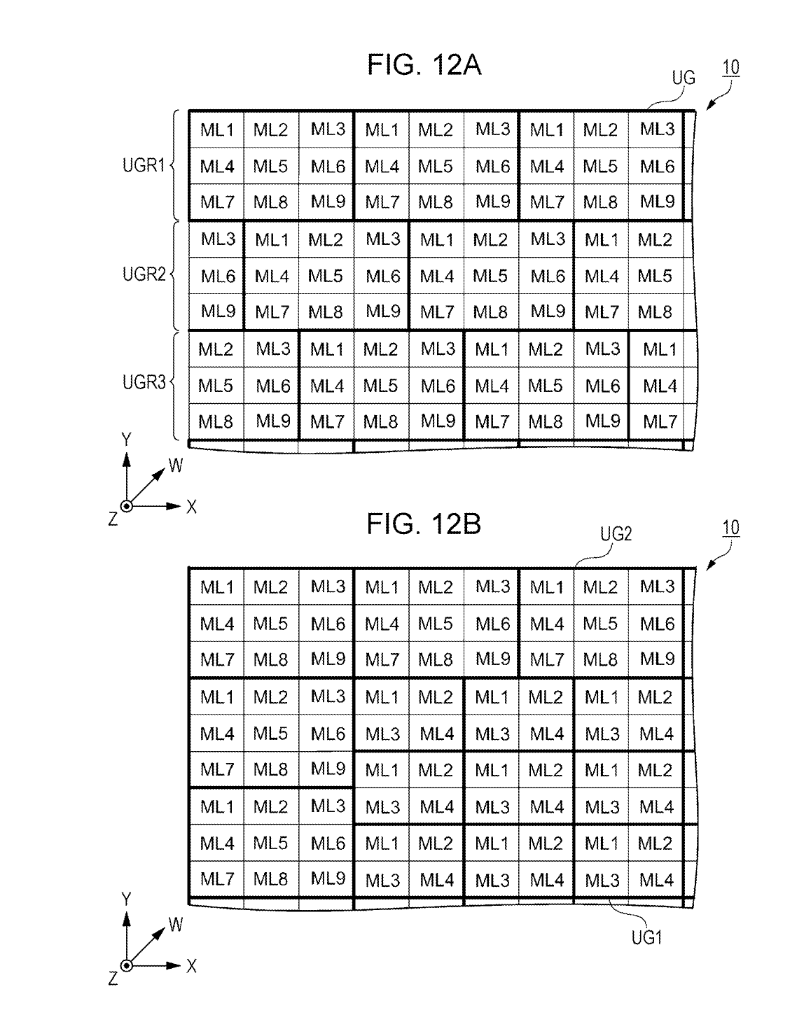

FIGS. 12A and 12B are diagrams which illustrate an example of a microlens array according to Embodiment 4. Next, description will be given of the microlens array 10 according to Embodiment 4 with reference to FIGS. 12A and 12B. Here, the same reference numbers are used for the same configuration sites as embodiments 1 to 3 and overlapping description will be omitted.

In the microlens array 10 of the present embodiment shown in FIGS. 12A and 12B, the arrangement of the unit cell groups UG which configure the microlens array 10 is different. Other than this, the microlens array 10 of the present embodiment is the same as embodiments 1 to 3. The arrangement of the unit cell groups UG in the microlens array 10 according to embodiments 1 to 3 described above is not limited to the forms described above. For example, as shown surrounded with a thick line in FIG. 12A, the configuration may be a configuration in which the unit cell groups UG where 3×3 microlenses ML are set as a unit are arranged by being shifted for each row or line of the unit cell groups UG. For example, as shown in FIG. 12A, by setting a configuration in which the unit cell groups UG, where 3×3 microlenses ML of the first row UGR1 of the unit cell groups UG, the second row UGR2 of the unit cell groups UG, and the third row UGR3 of the unit cell groups UG are set as a unit, are arranged by being shifted from each other, the arrangement pattern of the repetition of the microlenses ML is tripled every 9 cells regarding the line direction (the Y direction). In this manner, since the diffraction caused by the microlens array 10 is more strongly suppressed, the light utilization efficiency of the microlens array 10 further improves.

Furthermore, the unit cell group UG may have the first unit cell group UG1 and the second unit cell group UG2 and the number of the lenses which are arranged in the first unit cell group UG1 and the number of the lenses which are arranged in the second unit cell group UG2 may be different. For example, as shown in FIG. 12B, the first unit cell group UG1 where 2×2 microlenses ML are set as a unit and the second unit cell group UG2 where 3×3 microlenses ML are set as a unit may be combined.

In the example shown in FIG. 12B, the second unit cell group UG2 in which the arrangement pattern of the repetition of the microlenses ML is every 9 cells is arranged in the periphery section of the display region E and the first unit cell group UG1 in which the arrangement pattern is every 4 cells is arranged in the inside thereof. It is known that the diffraction of light caused by the microlens ML is more easily generated in the periphery section than in the central portion. Thus, by arranging the second unit cell group UG2, in which the period of the repetition is large compared to the first unit cell group UG1 which is arranged in the central portion, in the periphery section, it is possible to efficiently suppress the interference of diffracted light caused by the microlens ML.

### Embodiment 5

### Form where Manufacturing Method is Different

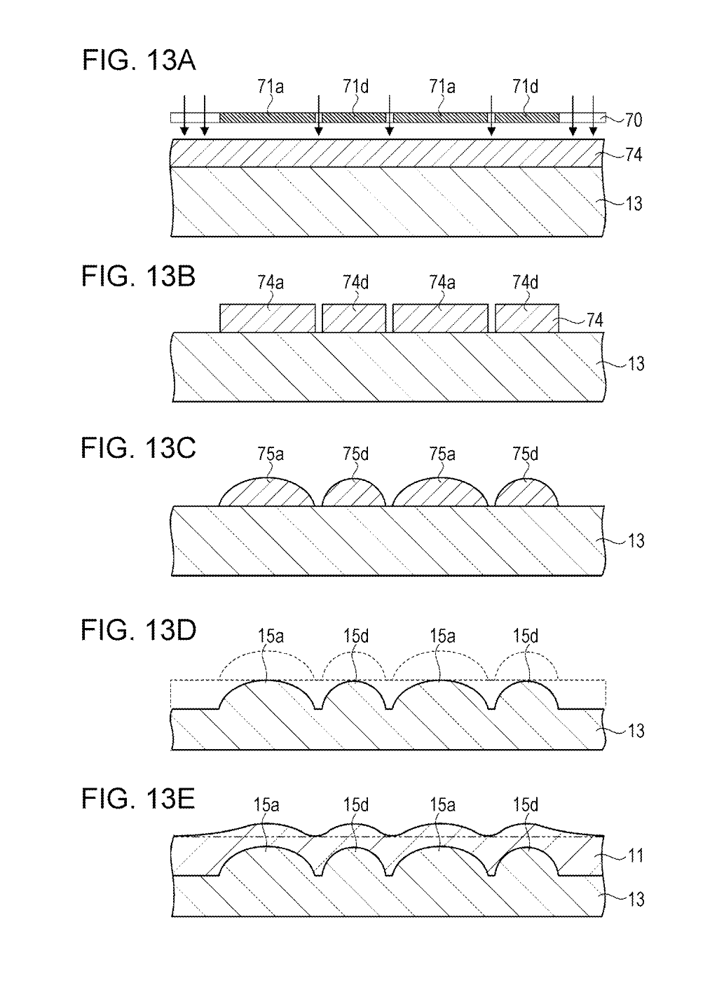

FIGS. 13A to 13E are schematic cross-sectional diagrams which show a method for manufacturing a microlens array according to Embodiment 5. Next, description will be given of the method for manufacturing the microlens array 10 according to Embodiment 5 with reference to FIGS. 13A to 13E. Here, the same reference numbers are used for the same configuration sites as Embodiment 1 and overlapping description will be omitted.

In Embodiment 1 (FIGS. 7A to 7D and FIGS. 8A to 8C), the microlens array 10 is manufactured by carrying out isotropic etching on the first transparent material 11; however, the manufacturing method is not limited thereto. For example, as shown in FIGS. 13A to 13E, it is also possible to manufacture the microlens array 10 using a resist reflow method. In other respects, the configuration is substantially the same as Embodiment 1. In the microlens array 10 of the present embodiment, the microlens array 10 is formed by etching the second transparent material 13.

The method for manufacturing the microlens array 10 in the present embodiment includes forming the second transparent material 13 on the substrate, forming a photoresist 74a which forms a first shape and a photoresist 74d which forms a second shape on the second transparent material 13, reflowing the photoresist 74a which forms the first shape and the photoresist 74d which forms the second shape, forming convex sections 15a and 15d on the second transparent material 13 by carrying out anisotropic etching on a reflowed photoresist 75a which forms the first shape, a reflowed photoresist 75d which forms the second shape, and the second transparent material 13, and covering the convex sections 15a and 15d with the first transparent material which has a different refractive index from the refractive index of the second transparent material 13. At this time, the direction of the first shape in plan view and the direction of the second shape in plan view are formed to be different.

Firstly, a base substrate of the microlens array 10 is prepared. In the present embodiment, a quartz substrate is used as the base substrate.

Next, as shown in FIG. 13A, the second transparent material 13 is formed on the base substrate. This forms the second transparent material 13 on the base substrate by a CVD method or the like. The second transparent material 13 is a silicon oxynitride film, a silicon nitride film, or the like. It is possible to accumulate the silicon oxynitride film, the silicon nitride film, or the like using a plasma CVD method or the like by setting mono-silane (SiH₄), nitrous oxide (N₂O), ammonia (NH₃), or the like as the raw material gas.

Next, using masks 71a and 71d, as shown in FIG. 13B, the forming of the photoresist 74a which forms the first shape and the photoresist 74d which forms the second shape on the second transparent material 13 proceeds. Since the microlenses ML are formed by inheriting the shape of the photoresists, the photoresists are formed to be a polygon which has substantially the same shape as the microlenses ML shown in FIG. 4. For example, the photoresists are formed to be a square and formed such that the directions of the photoresists, which are the microlenses ML which later configure the unit cell group UG, are different in plan view. As an example, the photoresists are formed such that the direction of the photoresist 74a which forms the first shape in plan view and the direction of the photoresist 74d which forms the second shape are different in plan view.

Next, as shown in FIG. 13C, the photoresist 74a which forms the first shape and the photoresist 74d which forms the second shape are reflowed and the reflowed photoresist 75a which forms the first shape and the reflowed photoresist 75d which forms the second shape are formed. According to this reflowing, the corner sections of the polygonal photoresists have an arc shape. That is, the shape of the photoresist after reflowing is substantially equal to the shape of the microlens ML shown in FIG. 4.

Next, as shown in FIG. 13D, the convex sections 15a and 15d are formed on the second transparent material 13 by carrying out anisotropic etching on the reflowed photoresist 75a which forms the first shape, the reflowed photoresist 75d which forms the second shape, and the second transparent material 13. At this time, etching is performed by making the etching rate of the photoresist and the etching rate of the second transparent material 13 substantially equal. In this manner, the shape of the second transparent material 13 which is formed after etching is substantially the same as the shape of the photoresist after reflowing. That is, the shape of the photoresist after reflowing is transferred to the second transparent material 13 and the second transparent material 13 has a convex shape. In a case in which the second transparent material 13 is a silicon oxynitride film or a silicon nitride film, in order to make the etching rate of the photoresist and the etching rate of the second transparent material 13 substantially equal, it is possible to use a plasma etching method such as a reactive ion etching method by setting carbon fluoride (for example, carbon tetrafluoride, CF₄) and oxygen as the raw material gas. It is possible to make the etching rate of the photoresist and the etching rate of the second transparent material 13 substantially equal by appropriately adjusting the ratio of carbon fluoride and oxygen at this time.

Next, as shown in FIG. 13E, covering the convex sections 15a and 15d with the first transparent material 11 which has a different refractive index from the refractive index of the second transparent material 13 is performed. In detail, the first transparent material 11 where the refractive index is lower than that of the second transparent material 13 is formed so as to cover the second transparent material 13 which forms a convex shape. It is possible to use a silicone oxide film as the first transparent material 11. Firstly, the first transparent material 11 which has a light transmitting property and which is formed of an inorganic material which has a lower refractive index than the second transparent material 13 is film-formed so as to cover the entire region of the second transparent material 13 with a convex shape. It is possible to form the first transparent material 11, for example, using a CVD method. Since the first transparent material 11 is formed so as to be accumulated on the upper surface of the second transparent material 13, the surface of the first transparent material 11 has an uneven shape in which unevenness caused by the second transparent material 13 is reflected. Thus, a planarizing process is carried out with respect to the film after accumulating the first transparent material 11. In the planarizing process, the upper surface of the first transparent material 11 is planarized by polishing and removing the portion in which the unevenness of the upper layer of the first transparent material 11 is formed, for example, using a chemical mechanical polishing method or the like. When the upper surface of the first transparent material 11 is planarized, the microlens array 10 is completed. When the microlens array 10 is completed, the surface of the second transparent material 13 with a convex shape is the concave portion 12.

The same effect as Embodiment 1 is obtained even when such a manufacturing method is adopted.

The invention is not limited to the embodiments described above and it is possible to add various types of changes or improvements to the embodiments described above. Modification examples will be described below.

### Modification Example 1

### Form where Shape of Flat Portion is Different

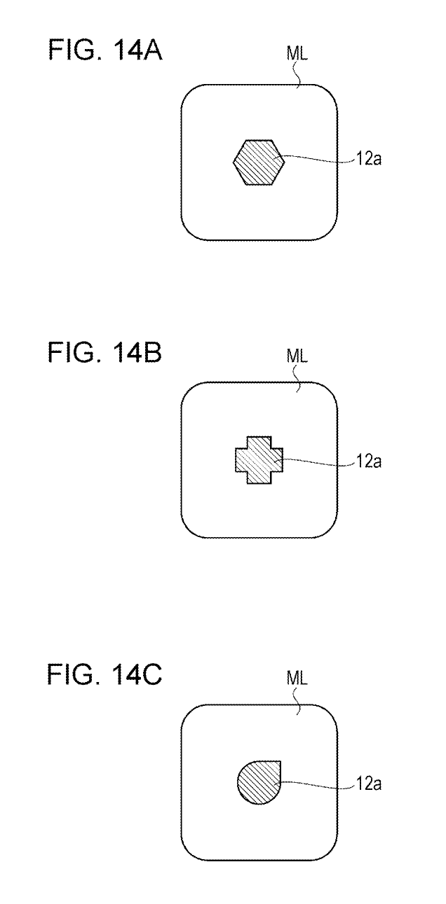

FIGS. 14A to 14C are diagrams which illustrate an example of a microlens according to modification example 1. Next, description will be given of the microlens array 10 according to modification example 1 with reference to FIGS. 14. Here, the same reference numbers are used for the same configuration sites as Embodiment 1 to 5 and overlapping descriptions will be omitted.

In the microlens array 10 of Embodiment 1, as shown in FIG. 4 or FIGS. 5A to 5C, the flat portion 12a is a quadrilateral. With respect to this, in the present modification example, the shape of the flat portion 12a is different. In other respects, the microlens array 10 of the present modification example is the same as Embodiment 1.

As shown in FIGS. 14A to 14C, as long as the shape of the flat portion 12a is a planar shape which does not show a rotational symmetry within ±15° around the center of the flat portion 12a, the planar shape is not limited. For example, as shown in FIG. 14A, the shape of the flat portion 12a may be a regular hexagon. The regular hexagon has a rotational symmetry of 60° around the center; however, the regular hexagon does not show rotational symmetry within ±15°. For this reason, it is possible to change the direction of the microlens ML within ±15° for each cell CL.

In addition, for example, as shown in FIG. 14B, the shape of the flat portion 12a may be a cross shape. The cross shape has a rotational symmetry of 90° around the center; however, the cross shape does not show rotational symmetry within ±15°. For this reason, it is possible to change the direction of the microlens ML within ±15° for each cell CL.

In addition, for example, as shown in FIG. 14C, the shape of the flat portion 12a may be a droplet shape in which a corner is provided in a portion of a circle. The droplet shape does not show rotational symmetry. For this reason, it is possible to change the direction of the microlens ML within ±15° for each cell CL.

As these examples show, the shape of the flat portion 12a may be any shape as long as the shape does not show a rotational symmetry of within ±15° around the center.

The entire disclosure of Japanese Patent Application No. 2014-008362, filed Jan. 21,2014 is expressly incorporated by reference herein.

What is claimed is:

1. A lens array comprising:
a plurality of lenses,
wherein the plurality of lenses include a first lens and a second lens which are each provided with a flat portion formed of a plurality of sides, and
a first lens direction which is an extended direction of one side of the flat portion of the first lens and a second direction which is an extended direction of one side of the flat portion of the second lens are different directions.

2. The lens array according to claim 1,
wherein the plurality of lenses are arranged so as to include a plurality of unit cell groups formed of M×N (M is an integer of 1 or more and N is an integer of 2 or more) lenses, and
extended directions of one side of a flat portion of each lens of one unit cell group out of the plurality of unit cell groups are each different directions.

3. The lens array according to claim 1,
wherein when an angle of the first lens direction with respect to a first direction is set as a first lens angle θ1 and an angle of the second lens direction with respect to the first direction is set as a second lens angle θ2, the first lens angle θ1 and the second lens angle θ2 are in a range from −15° to +15°.

4. The lens array according to claim 2,
wherein the plurality of unit cell groups are repeatedly arranged in a first direction.

5. The lens array according to claim 2,
wherein the plurality of unit cell groups have a first unit cell group and a second unit cell group, and
an arrangement of a plurality of lenses which are included in the first unit cell group is different from an arrangement of a plurality of lenses which are included in the second unit cell group.

6. The lens array according to claim 2,
wherein the plurality of unit cell groups have a first unit cell group and a second unit cell group, and
the number of a plurality of lenses which are included in the first unit cell group is different from the number of a plurality of lenses which are included in the second unit cell group.

7. A method for manufacturing a lens array, comprising:
forming a first transparent material;
forming a mask layer which has a first opening portion formed of a plurality of sides and a second opening portion formed of a plurality of sides on the first transparent material;
forming a plurality of concave portions in the first transparent material by carrying out isotropic etching on the first transparent material via the mask layer; and
filling the plurality of concave portion with a second transparent material which has a different refractive index from a refractive index of the first transparent material,
wherein an extended direction of one side of the first opening portion and an extended direction of one side of the second opening portion are different directions.

8. A method for manufacturing a lens array, comprising:
forming a second transparent material;
forming a photoresist which forms a first shape formed of a plurality of sides and forming a photoresist which forms a second shape formed of a plurality of sides on the second transparent material;
reflowing the photoresist which forms the first shape and the photoresist which forms the second shape;
forming a plurality of convex sections on the second transparent material by carrying out anisotropic etching on the photoresist which forms the first shape, the photoresist which forms the second shape, and the second transparent material; and
covering the plurality of convex sections with a first transparent material which has a different refractive index from the refractive index of the second transparent material,
wherein an extended direction of one side of the first shape and an extended direction of one side of the second shape are different directions.

9. An electro-optical device comprising:
the lens array according to claim 1.

10. An electro-optical device comprising:
the lens array according to claim 2.

11. An electro-optical device comprising:
the lens array according to claim 3.

12. An electro-optical device comprising:
the lens array according to claim 4.

13. An electro-optical device comprising:
the lens array according to claim 5.

14. An electro-optical device comprising:
the lens array according to claim 6.

15. An electro-optical device comprising:
a lens array which is manufactured by the method for manufacturing a lens array according to claim 7.

16. An electro-optical device comprising:
a lens array which is manufactured by the method for manufacturing a lens array according to claim 8.

17. An electronic apparatus comprising:
the electro-optical device according to claim 9.

18. An electronic apparatus comprising:
the electro-optical device according to claim 10.

19. An electronic apparatus comprising:
the electro-optical device according to claim 11.

20. An electronic apparatus comprising:
the electro-optical device according to claim 12.
